(19) United States
(12) Patent Application Publication
(10) Pub. No.: US 2026/0133686 A1
(43) Pub. Date: May 14, 2026

(54) METHOD, APPARATUS, DEVICE AND STORAGE MEDIUM FOR INTERFACE INTERACTION

(71) Applicant: Beijing Zitiao Network Technology Co., Ltd., Beijing (CN)

(72) Inventors: Yue Chen, Beijing (CN); Jinyi Wang, Beijing (CN)

(21) Appl. No.: 19/388,769

(22) Filed: Nov. 13, 2025

(30) Foreign Application Priority Data
Nov. 13, 2024 (WO) PCT/CN2024/131803

(51) Int. Cl. G06F 3/04847; G06F 3/04842

(52) U.S. Cl. CPC G06F 3/04847; G06F 3/04842

(57) ABSTRACT

Embodiments in the disclosure relate to a method, apparatus, device and a storage medium for interface interaction. The method provided in the disclosure includes: presenting an input panel and an information display area in an interactive interface of a content; presenting first description information in the information display area, the first description information indicating a first interaction of a first user to the content; switching, in response to receiving the first interaction, the information display area to present second description information, the second description information indicating a second interaction of a second user to the content; and based on first input information received via the input panel, sending a message corresponding to the first input information to the second user. In this manner, embodiments in the disclosure can improve the efficiency of user interactions.

### CROSS REFERENCE TO RELATED APPLICATION

The present application claims the priority to PCT/CN2024/131803 filed on November 13, 2024, which is incorporated herein by reference in its entirety.

### FIELD

Example embodiments in the disclosure generally relate to the field of computers, and in particular, to a method, apparatus, device, and computer-readable storage medium for interface interaction.

### BACKGROUND

In recent years, with the development of the Internet, more and more users are engaging interactive activities on network platforms, for example, publishing or browsing media content, recommending or commenting on media content, and the like. However, on traditional network platforms, the efficiency of users interacting with other users who have interacted with media content is low.

### SUMMARY

In a first aspect in the disclosure, there is provided a method for interface interaction, including: presenting an input panel and an information display area in an interactive interface of a content; presenting first description information in the information display area, the first description information indicating a first interaction of a first user to the content; in response to receiving the first interaction, switching, in response to receiving the first interaction, the information display area to present second description information, the second description information indicating a second interaction of a second user to the content; and sending, based on first input information received via the input panel, a message corresponding to the first input information to the second user.

In a second aspect in the disclosure, an apparatus for interface interaction is provided. The apparatus includes a first presenting module, configured to present an input panel and an information display area in an interactive interface of a content; a second presenting module, configured to present first description information in the information display area, the first description information indicating a first interaction of a first user to the content; a switching module, configured to, switch, in response to receiving the first interaction, the information display area to present second description information, the second description information indicating a second interaction of a second user to the content; and a sending module, configured to send, based on first input information received via the input panel, a message corresponding to the first input information to the second user.

In a third aspect in the disclosure, an electronic device is provided. The apparatus includes at least one processor; and at least one memory coupled to the at least one processor and storing instructions for execution by the at least one processor. The instructions, when executed by the at least one processor, cause the device to perform the method of the first aspect.

In a fourth aspect in the disclosure, a computer-readable storage medium is provided. The computer-readable storage medium stores a computer program, and the computer program is executable by the processor to implement the method of the first aspect.

It should be understood that the content described in Summary is not intended to limit the key features or important features of the embodiments in the disclosure, nor is it intended to limit the scope of the disclosure. Other features in the disclosure will become readily understood from the following description.

### BRIEF DESCRIPTION OF DRAWINGS

The above and other features, advantages, and aspects of various embodiments in the disclosure will become more apparent from the following detailed description taken in conjunction with the accompanying drawings. In the drawings, the same or similar reference numbers refer to the same or similar elements, where:

FIG. 1 illustrates a schematic diagram of an example environment in which some embodiments in the disclosure may be implemented in real time;

FIGS. 2A-2E illustrate example interfaces in accordance with some embodiments in the disclosure;

FIGS. 3A-3E illustrate example interfaces in accordance with further embodiments in the disclosure;

FIG. 4 shows a flowchart of an example process for interface interaction in accordance with some embodiments in the disclosure;

FIG. 5 illustrates a schematic structural block diagram of an example apparatus for interface interaction according to some embodiments in the disclosure; and

FIG. 6 illustrates a block diagram of an electronic device capable of implementing various embodiments in the disclosure.

### DETAILED DESCRIPTION

Embodiments in the disclosure will be described in more detail below with reference to the accompanying drawings. While certain embodiments in the disclosure are shown in the accompanying drawings, it should be understood that the disclosure may be implemented in various forms, and should not be construed as limited to the embodiments set forth herein, but rather, these embodiments are provided for a more thorough and complete understanding of the disclosure. It should be understood that the drawings and embodiments in the disclosure are for illustrative purposes only and are not intended to limit the scope of the disclosure.

It should be noted that the title of any section/subsection provided herein is not limiting. Various embodiments are described throughout, and any type of embodiments may be included in any section/subsection. Furthermore, the embodiments described in any section/subsection may be combined in any manner with the same section/subsection and/or any other embodiment described in different sections/subsections.

In the description of the embodiments in the disclosure, the terms “including” and the like should be understood to include “including but not limited to”. The term “based on” should be understood as “based at least in part on”. The terms “one embodiment” or “the embodiment” should be understood as “at least one embodiment”. The term “some embodiments” should be understood as “at least some embodiments”. Other explicit and implicit definitions may also be included below. The terms “first,” “second,” and the like may refer to different or identical objects. Other explicit and implicit definitions may also be included below.

Embodiments in the disclosure may relate to data of a user, acquisition and/or use of data, and the like. These aspects all follow the corresponding laws and regulations and related regulations. In the embodiments in the disclosure, all data collection, acquisition, processing, forwarding, use, etc., are performed on the premise that the user is aware and confirms. Accordingly, when implementing the embodiments in the disclosure, the type, the scope of use, and the usage scenario of the data or information that may be involved and the like should be informed to the user the authorization should be obtained from the user in an appropriate manner according to the relevant laws and regulations. The specific notification and/or authorization manner may vary according to actual situations and application scenarios, and the scope of the disclosure is not limited in this respect.

According to the solutions in the specification and the embodiments, for example, if the processing of personal information is involved, it will be performed on the premise of having a legality basis (e.g., obtaining the consent of a subject of the personal information, or it is necessary to perform a contract), and will be only processed within a specified or agreed scope. If a user refuses to process personal information other than the necessary information required for basic functions, it will not affect the use of the basic functions by the user.

As briefly mentioned above, with the development of the Internet, more and more users are engaging interactive activities on network platforms, for example, publishing or browsing media content, recommending or commenting on media content, and the like. However, on traditional network platforms, the efficiency of users interacting with other users who have interacted with media content is low, and it is difficult to meet user interaction requirements.

Embodiments in the disclosure provide a solution for interface interaction. According to the solution, an input panel and an information display area may be presented in an interactive interface of a content; first description information is presented in the information display area, and the first description information indicates a first interaction of a first user to the content; in response to receiving the first interaction, the information display area is switched to present second description information, and the second description information indicates a second interaction of a second user to the content; and a message corresponding to first input information is sent to the second user based on the first input information received via the input panel.

In this manner, embodiments in the disclosure may present an information display area and an input panel in an interactive interface of the content and may present description information in the information display area, indicating the interaction of other users on the content. In addition, the embodiments in the disclosure may switch the description information presented in the information display area based on operations of a current user. Therefore, the embodiments in the disclosure may present the description information of other users about the interaction of the content for the current user, and switch the description information corresponding to different users based on the operations of the user, thereby improving the efficiency of information presentation. Moreover, input information of the current user may be obtained based on the input panel, and the message corresponding to the input information is sent to the user corresponding to the description information, thereby improving the efficiency of interaction of the user, meeting the interaction requirement of the user.

Various example implementations of the solution are described in detail below in connection with the accompanying drawings.

### Example Environment

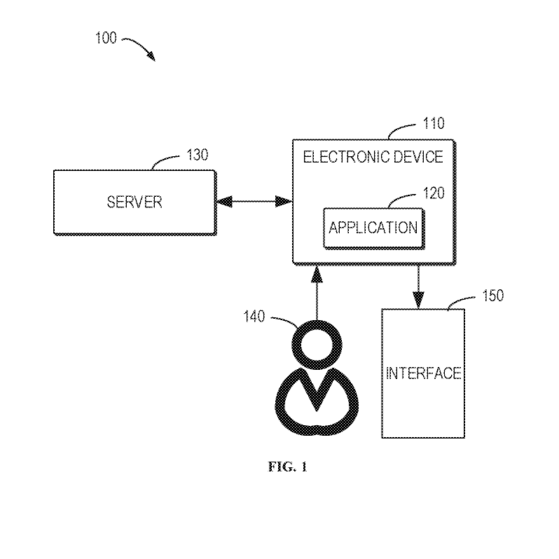

FIG. 1 illustrates a schematic diagram of an example environment 100 in which embodiments in the disclosure may be implemented. As shown in FIG. 1, the example environment 100 may include an electronic device 110.

In the example environment 100, an application 120 that supports interface interaction may run on an electronic device 110. The application 120 may be an application of any suitable type for interface interaction, examples of which may include, but are not limited to: a video application, a social application, or other suitable application. The user 140 may interact with the application 120 via the electronic device 110 and/or its attached device.

In the environment 100 of FIG. 1, if the application 120 is active, the electronic device 110 may present, via the application 120, an interface 150 supporting interface interactions.

In some embodiments, the electronic device 110 communicates with a server 130 to enable provisioning of services to the application 120. The electronic device 110 may be any type of mobile terminal, fixed terminal, or portable terminal, including a mobile phone, a desktop computer, a laptop computer, a notebook computer, a netbook computer, a tablet computer, a media computer, a multimedia tablet, a palmtop computer, a portable game terminal, a VR/AR device, a personal communication system (PCS) device, a personal navigation device, a personal digital assistant (PDA), an audio/video player, a digital camera/camcorder, a positioning device, a television receiver, a radio broadcast receiver, an electronic book device, a gaming device, or any combination of the foregoing, including accessories and peripherals of these devices, or any combination thereof. In some embodiments, the electronic device 110 may also support any type of interface for a user (such as a “wearable” circuit, etc. ).

The server 130 may be a standalone physical server, a server cluster composed of multiple physical servers, a distributed system, or a cloud server that provides basic cloud computing services such as cloud services, cloud databases, cloud computing, cloud functions, cloud storage, network services, cloud communications, middleware services, domain name services, security services, content distribution networks, and big data and artificial intelligence platforms. The server 130 may include, for example, a computing system/server, such as a mainframe, an edge computing node, a computing device in a cloud environment, or the like. The server 130 may provide a background service for the application 120 supporting interface interaction in the electronic device 110.

A communication connection may be established between the server 130 and the electronic device 110. The communication connection may be established in a wired manner or a wireless manner. The communication connection may include, but is not limited to, a Bluetooth connection, a mobile network connection, a Universal Serial Bus (USB) connection, a Wireless Fidelity (Wi-Fi) connection, and the like, and the embodiments in the disclosure are not limited in this aspect. In an embodiment in the disclosure, the server 130 and the electronic device 110 may implement signaling interaction through a communication connection between the server 130 and the electronic device 110.

It should be understood that the structures and functions of the various elements in the environment 100 are described for illustrative purposes only and do not imply any limitation to the scope of the disclosure.

Some example embodiments in the disclosure will be described below with continued reference to the accompanying drawings.

### Example Interaction

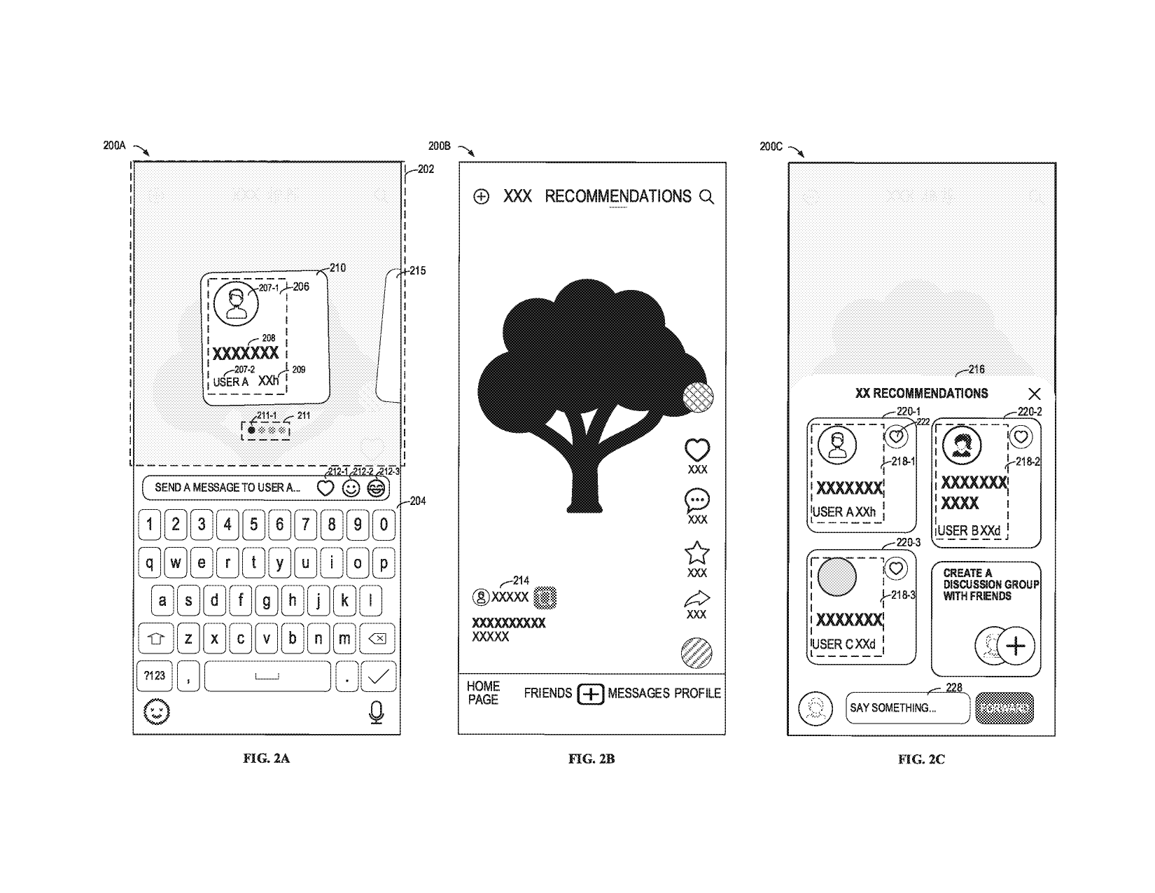

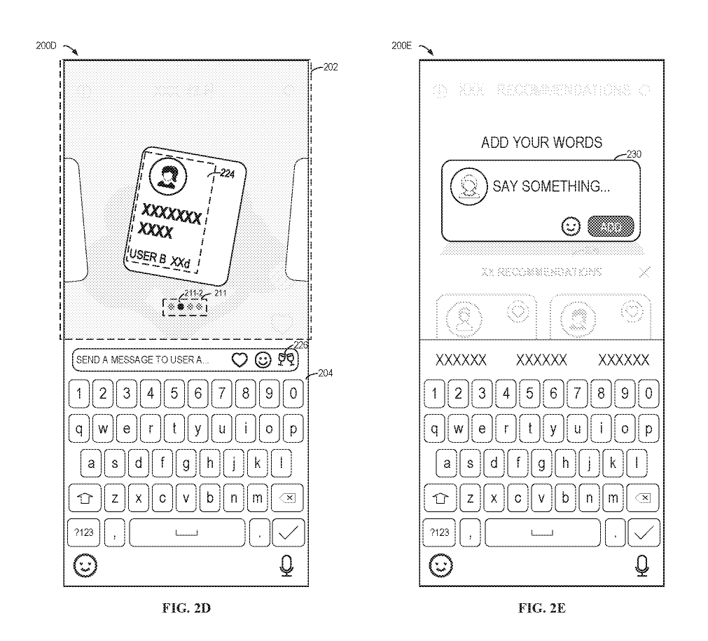

FIGS. 2A-2E illustrate example interfaces 200A-200E, in accordance with some embodiments in the disclosure. The interfaces 200A-200E may be provided, for example, by the electronic device 110 shown in FIG. 1.

In some embodiments, the electronic device 110 may present an interactive interface 200A of a content. The electronic device 110 may present an information display area 202 in the interactive interface 200A of the content. As an example, the information display area 202 may be in an upper half of the interactive interface 200A. As an example, the content may include a media content work, such as a video work, a graphic work, and a musical work.

As an example, the electronic device 110 may present first description information 206 in the information display area 202. For example, the first description information indicates a first interaction of a first user to the content. In some embodiments, the first interaction may include a recommended operation of the content by the first user. For example, the first interaction may further include a like, a comment, a recommendation, and the like of the content by the first user.

Additionally or alternatively, the first description information may include comments added by the first user to recommend the content. As an example, as shown in FIG. 2A, the electronic device 110 may present a comment 208 added by the first user to recommend the content.

Additionally or alternatively, the first description information may include identification information of the first user. For example, the identification information may include image identification 207 -1 (e.g., an avatar) and/or text identification 207 -2 (e.g., a username “user A”).

Additionally or alternatively, the electronic device 110 may present time information 209 associated with the first interaction. For example, the time information 209 may indicate a time at which the first interaction occurred or a duration relative to the current time (e.g., “XX hours ago”).

In some embodiments, the electronic device 110 may present a card component 210 corresponding to the first description information 206. As an example, the card component 210 as shown in FIG. 2A is only an example illustration. In actual application, the card component 210 may correspond to different shapes (e.g., circles, triangles, irregular patterns, etc.), different display angles or different colors, etc., and the disclosure is not intended to limit the specific presentation form of the card component 210.

In some embodiments, the display style of the first description information 206 is determined based on a length (e.g., a number of text words) of the comment content (e.g., comment 208) added by the first user for the first interaction. As an example, in order to achieve a better presentation effect, the electronic device 110 may determine a font size, a row display length, and the like of the comment content based on the length of the comment content (e.g., the number of characters of the comment content). As an example, the electronic device 110 may display, in response to the length of the comment content not exceeding a preset threshold (e.g., the number of characters is 5), the comment content based on a first font size (e.g., size four) in the same line. As an example, the electronic device 110 may present the comment content based on a second font size (e.g., size five) in response to the length of the comment content exceeding a preset threshold. The electronic device 110 may display a maximum of 5 characters in the same row and display the excess characters in a line break.

As an example, the display style of the first description information may be associated with a presentation position of each piece of content in the first description information 206. As an example, the electronic device 110 may move up the presentation position of the image identification 207-1 based on the length of the comment content exceeding the first threshold. As an example, the electronic device 110 may also move down the text identification 207-2 and the time information 209 in response to the length of the content exceeding the first threshold. For example, the electronic device 110 may further present only part of the comment content in the first description information 206 in response to the length of the comment content exceeding the first threshold. Further, the electronic device 110 may present the hidden part of the comment content in response to receiving a sliding operation on the comment content.

In some embodiments, the length and/or width of the card component 210 may be determined based on the length of the comment content.

Additionally, the electronic device 110 may present an input panel 204 in the interactive interface 200A. As an example, the input panel 204 may include a keyboard component to obtain input information of a current user. As an example, the input information may include text content, image content, and/or voice content. For example, the electronic device 110 may send a message corresponding to the input information to the first user based on the input information received via the input panel 204.

As an example, the electronic device 110 may present a set of interactive controls in the input panel. As an example, the set of interactive controls may include one or more interactive controls. For example, the set of interactive controls may include interactive control 212-1, interactive control 212-2, and interactive control 212-3.

In some embodiments, the set of interactive controls may correspond to predetermined interactive feedback, for example, likes, applause, and the like. The user may, for example, generate feedback for the content on which the user A has performed the interaction by triggering the interactive control, and the feedback may be sent to the user A via a private message or a message notification, for example.

In some embodiments, the set of interactive controls may display a predetermined graphical element, and the graphical element may correspond to a predetermined interactive expression, for example. Taking FIG. 2A as an example, the interactive control 212-1 may display a heart-shaped element, and may correspond to an interactive expression “like”. Correspondingly, after the current user clicks the interactive control 212-1, the client corresponding to the user A may push a notification or private message about the content liked by the current user.

In some embodiments, the type corresponding to the set of interactive controls may be a predetermined type. For example, all users may be associated with the same type of interactive controls.

In some other embodiments, the type corresponding to the set of interactive controls may also be dynamically determined. In some scenarios, the type of interactive controls may be determined based on first reference information associated with the content. As an example, the electronic device 110 may display, in response to first reference information associated with the content, for example, indicating that the content is media content associated with a festival (e.g., spring festival), an interactive control for generating holiday greetings, which may be, for example, fireworks. As an example, the content may be, for example, media content related to “puppy”, and the set of interactive controls may include graphical elements associated with “puppy”.

Additionally or alternatively, the type of interactive controls may be determined based on second reference information associated with the current user. The second reference information may be obtained with the knowledge and permission of the current user. As an example, the second reference information may indicate that the current user is more compatible with the "applause" control. Correspondingly, the electronic device may display an interactive control for generating an applause feedback, and the graphical element may be, for example, a palm.

Additionally or alternatively, the type of interactive controls may be determined based on third reference information associated with the first user. The third reference information may be obtained with the knowledge and permission of the first user. As an example, the third reference information may indicate that the status set by the first user in the application 120 is "in a party". Correspondingly, correspondingly, the electronic device may display an interactive control for generating a toast feedback, and the graphical element may be, for example, a wine glass.

In some embodiments, the display order of the set of interactive controls may be a predetermined order. For example, all users may be associated with the set of interactive controls in the same order.

In some embodiments, the display order of the set of interactive controls may be determined based on the first reference information, the second reference information, and/or the third reference information. For example, the electronic device 110 may preferentially present the interactive controls associated with the content from left to right.

In some embodiments, the electronic device 110 may obtain the input information based on a third operation on a target interactive control in the set of interactive controls. As an example, the electronic device 110 may obtain the input information corresponding to the target interactive control based on a click or a long-press on the target interactive control (e.g., the interactive control 212-1) in the set of interactive controls. As an example, the input information corresponding to the interactive control 212-1 may include, e.g., a predetermined graphical element (e.g., a “heart” element) and/or predetermined text content (e.g., “like the video recommended by you”).

In some embodiments, the electronic device 110 may present, in the interactive interface, an animation process associated with the graphical element in the target interactive control in response to receiving the third operation on the target interactive control. As an example, the electronic device 110 may present, in the interactive interface, the animation process associated with the graphical element (e.g., a “heart” element) in the interactive control 212-1 in response to receiving a click on the interactive control 212-1. For example, the animation process may include a process of moving a plurality of graphical elements (e.g., “heart” elements) from the input panel 204 to the first description information 206. As an example, the animation process may further include a process in which the plurality of graphic elements are moving from large to small and gradually disappearing.

In some embodiments, the electronic device 110 may present an indication element 211 associated with the set of description information in the interactive interface 200A. The set of description information corresponds to interactions of a group of users to the content. As an example, the indication element 211 may indicate the number of the set of description information associated with the content. Further, the electronic device 110 may indicate the order of the first description information in the set of description information based on the indication element 211. For example, the electronic device 110 may distinguish, in the indication element 211, the first part corresponding to the first description information currently presented in the information display area 202. For example, the electronic device 110 may distinguish the first part 211-1 corresponding to the first description information. As an example, the distinguishing display may include, for example, bolding, adjusting the display color, adjusting the size, and the like.

In some embodiments, the electronic device 110 may present an interactive panel associated with the content in response to receiving a viewing request associated with the content.

In some embodiments, as shown in FIG. 2B, the interactive interface of the content includes a viewing interface 200B of the content. The electronic device 110 may present a target element 214 in the viewing interface 200B. The target element 214 may indicate an interaction associated with the content. In some embodiments, the interaction may be a recommendation for the content. For example, the interaction may include a like on the content, a comment, a recommendation, and the like. Further, the electronic device 110 may present the interactive panel in response to a trigger (e.g., a click or a long-press) on the target element 214.

In some embodiments, as shown in FIG. 2C, the electronic device 110 may present an interactive panel 216 in the interactive interface 200C. The electronic device 110 may present a set of description information in the interactive panel 216. The set of description information includes at least the foregoing first description information (e.g., the first description information 206 shown in FIG. 2A).

In some embodiments, the electronic device 110 may present a set of cards corresponding to the set of description information in the interactive panel 216. For example, the electronic device 110 may present the card 220-1 corresponding to the description information 218-1, the card 220-2 corresponding to the presentation description information 218-2, and the card 220-3 corresponding to the presentation description information 218-3. As an example, the display style of the cards may be determined based on the length of the content of the comment added by the user, for example, the electronic device 110 may determine that the length of the card 220-2 is greater than that of the card 220-1 in response to the length of the comment content in the description information 218-2 being greater than the comment content in the description information 218-1.

Alternatively, the electronic device 110 may present interactive controls in the cards. For example, the electronic device 110 may present the interactive control 222 in the card 220-1. Further, the electronic device 110 may send predetermined feedback associated with the interactive control (e.g., a graphic element or a predetermined text message in the interactive control 222) to a user (e.g., user A) associated with the interactive control in response to triggering the interactive control (e.g., the interactive control 222).. As an example, the type of interactive control 222 may be determined based on the content, the current user, or the user associated with the interactive control.

As an example, the electronic device 110 may present the input panel and the information display area (e.g., the input panel 204 and the information display area 202 as shown in FIG. 2A) in response to a selection of the first description information (e.g., the description information 218-1 as shown in FIG. 2C) of the set of description information.

In some embodiments, with continued reference to FIG. 2A, the electronic device 110 may switch the information display area to present the second description information in response to receiving the first interaction. The second description information indicates a second interaction of a second user to the content. In some embodiments, the second interaction may include a recommendation of the content by the second user. For example, the second interaction may further include a like, a comment, a recommendation, and the like by the second user on the content.

In some embodiments, the first interaction may include a sliding operation associated with a first interaction area of the information display area 202. As an example, the first interactive area may include all areas of the information display area 202. As an example, the first interaction area may include an area to which the card component 210 is presented.

In some embodiments, the first interaction may include a click associated with a second interactive area of the information display area 202. As an example, the second interactive area may include all areas of the information display area 202. As an example, the electronic device 110 may present the indication element 215 in the information display area 202. The indication element 215 may be associated with the second description information. The first interaction may include a click on the indication element 215.

In some embodiments, the electronic device 110 may determine the second description information from the set of description information based on a display order of the set of description information in the interactive panel in response to receiving the first interaction. As an example, as shown in FIG. 2C, the display order of the description information 218-2 in the interactive panel 216 is next to the description information 218-1 (e.g., corresponding to the first description information 206 in FIG. 2A) in the order from left to right and from top to bottom. Further, the electronic device 110 may determine that the second description information is the description information 218-2 based on the display order of the description information 218-1 and the description information 218-2 in the interactive panel 216.

Alternatively or additionally, the electronic device 110 may present an animation process of switching the first card component (e.g., card component 210) corresponding to the first description information to the second card component corresponding to the second description information in the interactive interface in response to receiving the first interaction. As an example, the animation process may include a process of moving the first card and/or the second card in the information display area 202 and/or a process of fading in and out, etc. The present disclosure is not intended to limit the specific form of the animation process.

In some embodiments, as shown in FIG. 2D, the electronic device 110 may present the second description information 224 in the information display area 202 of the interactive interface 200D. The second description information 224 may include a comment added by the second user to recommend the content, identification information of the second user, time information associated with the second interaction, and the like.

Alternatively, the electronic device 110 may adjust at least one interactive control of the set of interactive controls in the input panel 204 based on the reference information associated with the second user. As an example, in response to the status in the application 120 is set by the second user currently as "in a party", the electronic device 110 may adjust at least one control of the set of interactive controls to an interactive control associated with "party" (for example, the interactive control 226 in FIG. 2D is different from the interactive control 212-3 in FIG. 2A ).

As an example, the electronic device 110 sends a message corresponding to the first input information to the second user via the first input information received via the input panel 204. As an example, the process in which the electronic device 110 receives the first input information via the input panel 204 may refer to the foregoing description of receiving the input information using the input panel 204, and details are not described herein again.

Alternatively or additionally, the electronic device 110 may update the indication element 211 to indicate the order of the second description information in the set of description information in response to the information display area 202 switching to present the second description information. For example, the electronic device 110 distinguishes the second part corresponding to the second description information currently presented in the display information display area 202 in the indication element 211. For example, the electronic device 110 may distinguish the second part 211-2 corresponding to the second description information. As an example, the distinguishing display may include, for example, bolding, adjusting the display color, adjusting the size, and the like.

In some embodiments, with continued reference to FIG. 2C, the electronic device 110 may present, in the interactive panel, an input control 228 associated with the interaction. Further, the electronic device 110 may present a recommendation panel in the interactive interface in response to a selection of the input control 228.

In some embodiments, as shown in FIG. 2E, the electronic device 110 may present the recommendation panel 230 in the interactive interface 200E. Further, the electronic device 110 may obtain the second input information via the recommendation panel 230 (e.g., obtain the second input information input by the current user via the input panel 232) as the comment added by the current user for the interaction (e.g., a recommendation) of the content. As an example, the electronic device 110 may, in response to receiving the confirmation of the second input information by the current user, use the second input information as a comment added by the current user for the interaction on the content.

In some embodiments, the electronic device 110 may perform an interaction (e.g., recommending the content) on the content based on receiving the confirmation that the current user does not perform the interaction on the content and use the second input information as a comment added by the current user for the interaction on the content.

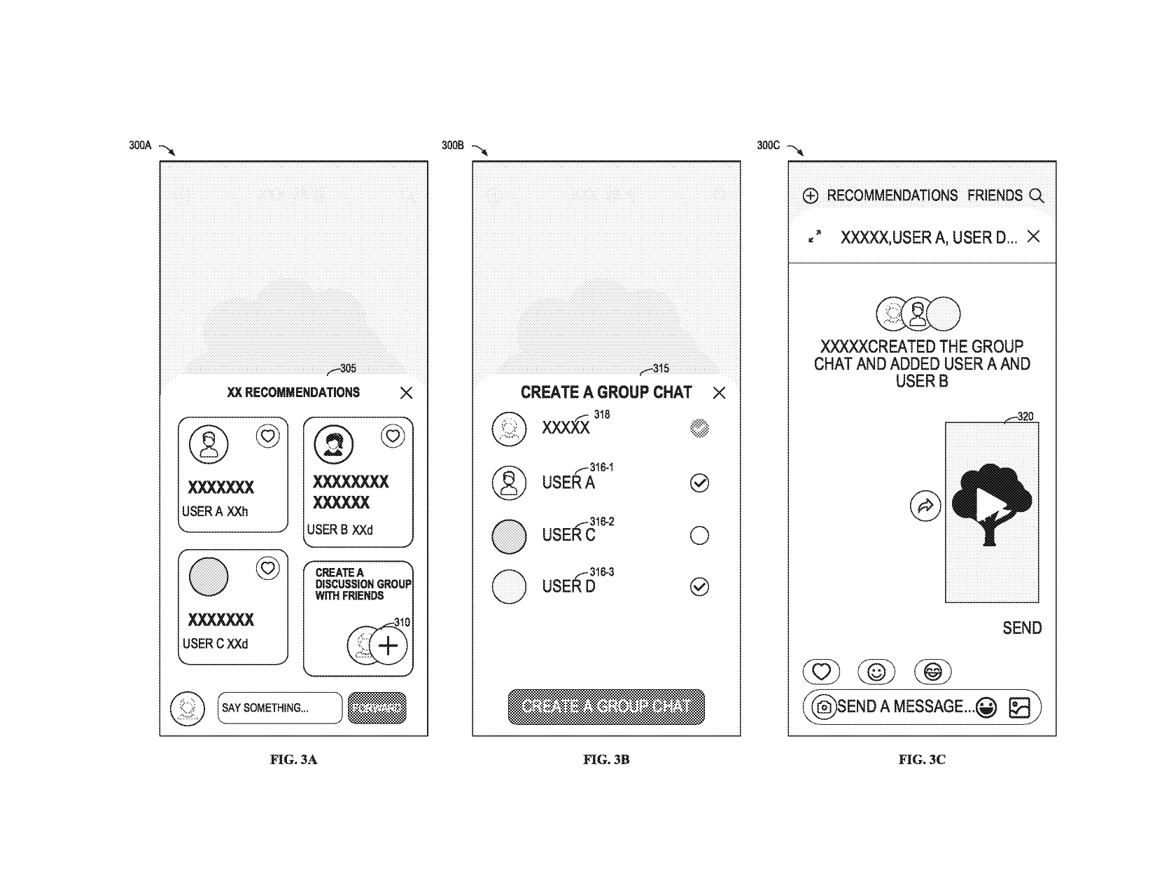

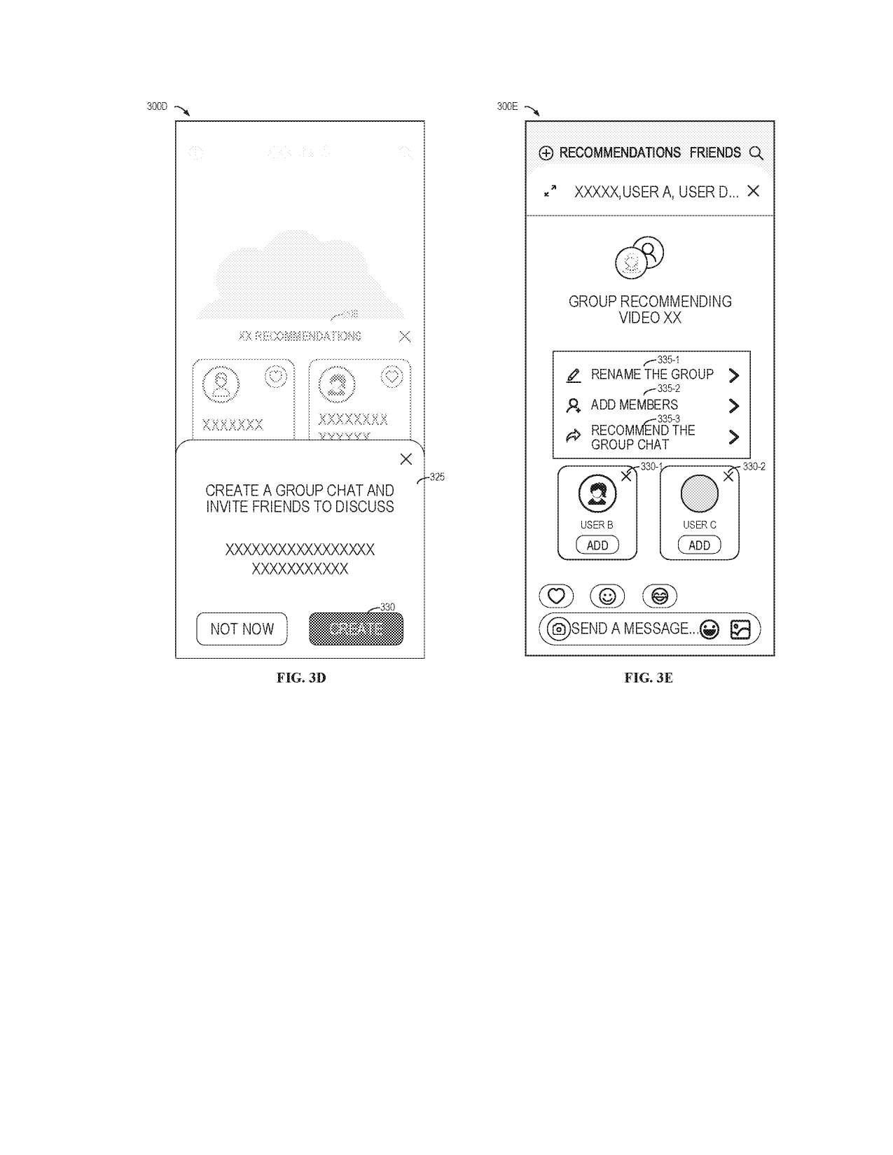

FIGS. 3A-3E illustrate example interfaces 300A-300E in accordance with further embodiments in the disclosure. The interface 300A to the interface 300E may be provided, for example, by the electronic device 110 shown in FIG. 1.

In some embodiments, as shown in FIG. 3A, the electronic device 110 may present an interactive interface 300A of the content. The electronic device 110 may present an interactive panel 305 in the interactive interface 300A.

As an example, the electronic device 110 may present, in the interactive panel, a set of description information associated with a set of interactions on the content. The set of description information may correspond to a group of users.

For example, the electronic device 110 may present a group interaction entry 310 in the interactive panel 305. As an example, the electronic device 110 may present a card corresponding to the group interaction entry 310 in the interactive panel 305. As an example, the electronic device 110 may also present descriptive text (e.g., “establish a discussion group with friends”) for the group interaction entry 310.

In some embodiments, the electronic device 110 may send a message associated with the content in a target group in response to a selection of the group interaction entry 310 in the interactive panel 305.

Additionally, the target group is created based on a selection of the group interaction entry 310. In some embodiments, in addition to the current user, the members in the target group may further include at least one user determined from the combination of users who have recommended contents, and the association relationship between the at least one user and the current user satisfies the predetermined conditions. As an example, the association relationship between the at least one user and the current user satisfies the predetermined condition may include, for example: at least one user and the current user follow each other, or at least one user and the current user are friends in the current application, etc.

In some embodiments, before creating the target group, the electronic device 110 may present a group configuration interface in response to a trigger (e.g., a click) for a group creation entry 310.

As an example, as shown in FIG. 3B, the electronic device 110 may present the group configuration interface 315 in the interactive interface 300B. The electronic device 110 may present a group of candidate users in the group configuration interface 315. For example, the group of candidate users may include, for example, user 316-1, user 316-2, and user 316-3. As an example, the electronic device 110 may also present the current user 318 in the selected state in the group configuration interface 315 to indicate that the current user is included in the created target group by default. As an example, the group of candidate users are all users whose association relationship with the current user satisfies a predetermined condition in a group of users corresponding to the set of description information.

As an example, the electronic device 110 may receive a selection of at least one user from the group of candidate users and add the selection to the target group to be created.

In some embodiments, as shown in FIG. 3C, the electronic device 110 may present a conversation interface 300C of the target group in response to the target group being created. The electronic device 110 may present a message 320 associated with the content sent by the current user in the conversation interface 300C. As an example, the message 320 may include image content corresponding to the content and/or predetermined text content for the content (e.g., “It seems that everyone likes this content”), etc.

Alternatively, the electronic device 110 may also present creation information of the target group in the conversation interface 300C. For example, the creation information may include a creator (e.g., the current user) of the target group, a group member, a creation time of the target group, and the like.

In some embodiments, as shown in FIG. 3D, the electronic device 110 may present a group creation panel 325 in the interactive interface 300D. As an example, the electronic device 110 may present a group interaction entry 330 in the group creation panel 325.

For example, the electronic device 110 may present the group creation panel 325 in the interactive interface 300D in response to the number of users whose association relationship with the current user satisfying a predetermined condition in the group of users corresponding to the set of description information in the interactive panel 305 satisfying the preset number (e.g., 2).

Additionally, the electronic device 110 may create the target group in response to a trigger (e.g., a click) on the group interaction entry 330. At this time, the members in the target group only include the current user.

In some embodiments, after creating the target group, as shown in FIG. 3E, the electronic device 110 presents a conversation interface 300E of the target group. The electronic device 110 may present the group of candidate users in the conversation interface 300E of the target group.

As an example, the electronic device 110 may present a set of cards corresponding to the group of candidate users. The set of candidate users may include, for example, user 330-1 and user 330-2. Further, the electronic device 110 may receive a selection of at least one user from the group of candidate users by the current user, and add the at least one user to the target group.

Alternatively, the electronic device 110 may present a modification control 335-1 in the conversation interface 300E for modifying the name of the target group. The electronic device 110 may present an add control 335-2 in the conversation interface 300E for adding more users into the target group. The electronic device 110 may present a recommendation control 335-3 in the conversation interface 300E for sharing the target group.

Based on the process described above, the embodiments in the disclosure may present an information display area and an input panel in the interactive interface of the content, and description information in the information display area to indicate interactions of other users on the content. In addition, the embodiments in the disclosure may switch the description information presented in the information display area based on the operation of the current user. Moreover, the embodiments in the disclosure may provide users with a convenient way to create groups.

In this manner, the embodiments in the disclosure can conveniently present the description information of other users about the interactions on the content to the current user, and switch the description information corresponding to different users based on the operation of the user, thereby improving the efficiency of information presentation. Moreover, the input information of the current user can be obtained based on the input panel, and the message corresponding to the input information is sent to the user corresponding to the description information, thereby improving the interaction efficiency of the user and meeting the interaction requirement of the user. In addition, the embodiments in the disclosure can meet the requirement of the user to create a group to communicate with more users.

### Example Processes

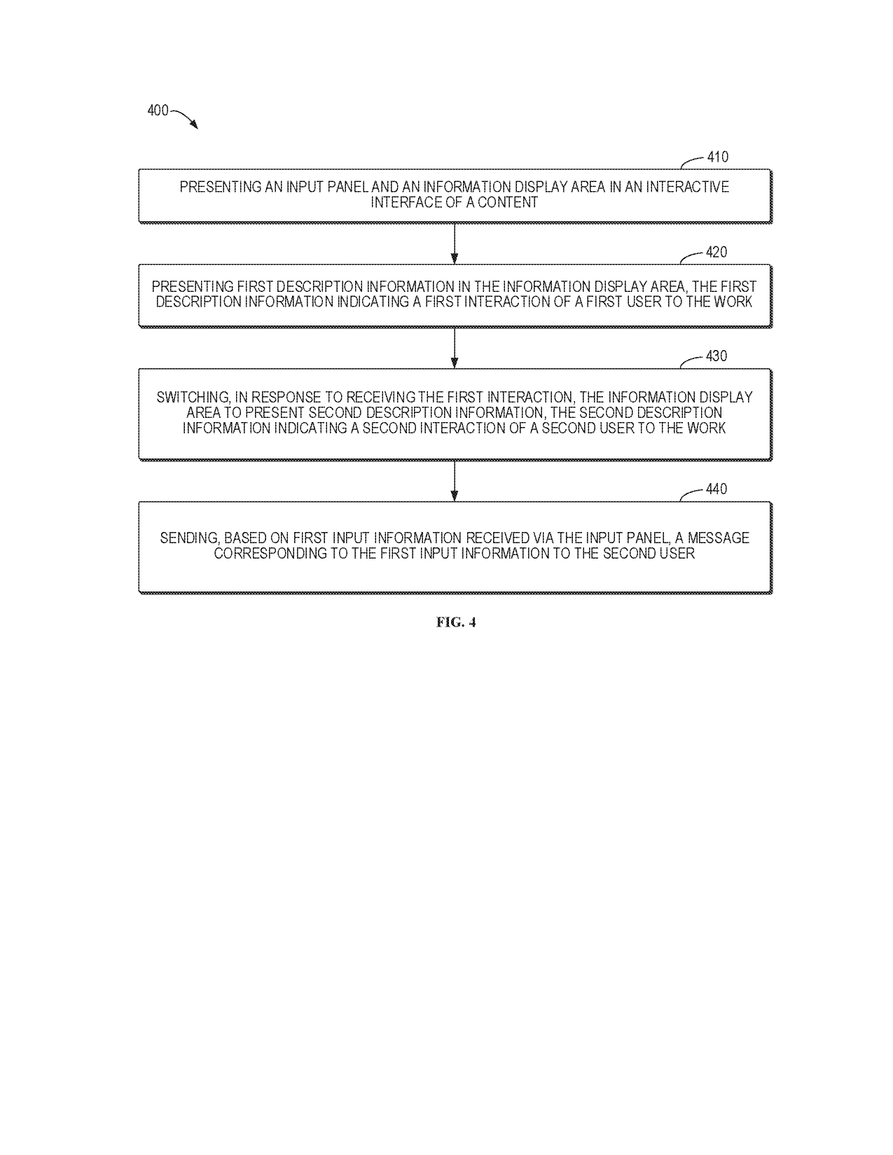

FIG. 4 illustrates a flowchart of an example process 400 of interface interaction in accordance with some embodiments in the disclosure. Process 400 may be implemented at the electronic device 110. The process 400 is described below with reference to FIG. 1.

As shown, in block 410, the electronic device 110 presents an input panel and an information display area in an interactive interface of a content.

In block 420, the electronic device 110 presents first description information in the information display area, the first description information indicating a first interaction of a first user to the content.

At block 430, the electronic device 110 switches, in response to receiving the first interaction, the information display area to present second description information indicating a second interaction of a second user to the content.

At block 440, the electronic device 110 sends, based on first input information received via the input panel, a message corresponding to the first input information to the second user.

In some embodiments, presenting the input panel and the information display area in the interactive interface of the content includes: in response to receiving a viewing request associated with the content, presenting an interactive panel associated with the content, the interactive panel presenting a set of description information, the set of description information including at least the first description information; and in response to a selection of the first description information in the set of description information, presenting the input panel and the information display area.

In some embodiments, the interactive panel further includes a group interaction entry, and the process 400 further includes: in response to a selection of the group interaction entry in the interactive panel, sending a message associated with the content in a target group that is created based on the selection of the group interaction entry.

In some embodiments, the target group includes at least one user determined from a set of users that have recommended the content, and an association relationship between the at least one user and a current user satisfying a predetermined condition.

In some embodiments, the process 400 further includes: presenting a group of candidate users determined from a group of users corresponding to the set of description information, the association relationship between the group of candidate users and the current user satisfying a predetermined condition; and receiving a selection of the at least one user in the group of candidate users to be added to the target group.

In some embodiments, presenting the group of candidate users determined from the group of users corresponding to the set of description information includes: presenting the group of candidate users in a group configuration interface before creating the target group; or presenting the group of candidate users in a conversation interface of the target group after creating the target group.

In some embodiments, the process 400 further includes: presenting, in the interactive panel, an input control associated with an interaction; and in response to a selection of the input control, presenting a recommendation panel in the interactive interface; and obtaining, via the recommendation panel, second input information as a comment added by the current user for the interaction of the content.

In some embodiments, the interactive interface includes a viewing interface of the content, and the process 400 further includes: presenting a target element in the viewing interface, the target element indicating an interaction associated with the content; and in response to triggering of the target element, presenting the interactive panel.

In some embodiments, the process 400 further includes: presenting, in the interactive panel, a set of cards corresponding to the set of description information.

In some embodiments, the process 400 further includes: in response to receiving the first interaction, determining the second description information from the set of description information based on a display order of the set of description information in the interactive panel.

In some embodiments, the first interaction includes at least one of: a sliding operation associated with a first interactive area of the information display area; or a click operation associated with a second interactive area of the information display area.

In some embodiments, presenting the first description information includes: presenting, in the information display area, a card component corresponding to the first description information.

In some embodiments, the process 400 further includes: in response to receiving the first interaction, presenting an animation process of switching a first card component corresponding to the first description information to a second card component corresponding to the second description information.

In some embodiments, the process 400 further includes: presenting, in the interactive interface, an indication element associated with the set of description information, the set of description information corresponding to a set of interactions of a group of users to the content; and in response to the information display area switching to present the second description information, updating the indication element to indicate an order of the second description information in the set of description information.

In some embodiments, the first description information includes at least one of the following: a comment added by the first user to recommend the content; identification information of the first user; or time information of the first user recommending the content.

In some embodiments, the first interaction and/or the second interaction includes a recommendation operation for the content.

In some embodiments, the process 400 further includes: presenting a set of interactive controls in the input panel; and in response to a selection of a target interactive control in the set of interactive controls, obtaining the input information.

In some embodiments, a control type and/or a display order of the set of interactive controls is determined based on at least one of: first reference information associated with the content; second reference information associated with the current user; or third reference information associated with the first user or the second user.

In some embodiments, a display style of the first description information is determined based on a length of comment content added by the first user for the first interaction.

### Example Apparatus and Apparatus

Embodiments in the disclosure also provide corresponding apparatuses for implementing the above methods or processes. FIG. 5 shows a schematic structural block diagram of an example apparatus 500 for interface interaction in accordance with some embodiments in the disclosure. The apparatus 500 may be implemented or included in an electronic device. The various modules/components in the apparatus 500 may be implemented by hardware, software, firmware, or any combination thereof.

As shown in FIG. 5, the apparatus 500 includes a first presenting module 510 configured to present an input panel and an information display area in an interactive interface of a content; a second presenting module 520 configured to present first description information in the information display area, the first description information indicating a first interaction of a first user to the content; a switching module 530 configured to switch, in response to receiving the first interaction, the information display area to present second description information, the second description information indicating a second interaction of a second user to the content; and a sending module 540 configured to send, based on first input information received via the input panel, a message corresponding to the first input information to the second user.

In some embodiments, the first presentation module 510 is further configured to: in response to receiving a viewing request associated with the content, present an interactive panel associated with the content, the interactive panel presenting a set of description information, the set of description information including at least the first description information; and present the input panel and the information display area in response to selection of the first description information in the set of description information.

In some embodiments, the interactive panel further includes a group interaction entry, and the apparatus 500 further includes a group module configured to: in response to a selection of the group interaction entry in the interactive panel, send a message associated with the content in the target group that is created based on the selection of the group interaction entry.

In some embodiments, the target group includes at least one user determined from a set of users that have recommended the content, and an association relationship between the at least one user and a current user satisfies a predetermined condition.

In some embodiments, the apparatus 500 further includes an adding module configured to: present a group of candidate users determined from a group of users corresponding to the set of description information, the association relationship between the group of candidate users and the current user satisfying a predetermined condition; and receive a selection of the at least one user in the group of candidate users to be added to the target group.

In some embodiments, the adding module is further configured to: before creating the target group, present the group of candidate users in the group configuration interface; or after creating the target group, present the group of candidate users in a conversation interface of the target group.

In some embodiments, the apparatus 500 further includes a comment module configured to: present, in the interactive panel, an input control associated with an interaction; and in response to a selection of the input control, present a recommendation panel in the interactive interface; and obtain, via the recommendation panel, second input information as a comment added by the current user for the interaction of the content.

In some embodiments, the interactive interface includes a viewing interface of the content, and the apparatus 500 further includes an interaction module configured to: present a target element in the viewing interface, the target element indicating an interaction associated with the content; and present the interactive panel in response to a trigger for the target element.

In some embodiments, the apparatus 500 further includes a card module configured to present, in the interactive panel, a set of cards corresponding to the set of description information.

In some embodiments, the apparatus 500 further includes a determining module, configured to: in response to receiving the first interaction, determine the second description information from the set of description information based on a display order of the set of description information in the interactive panel.

In some embodiments, the first interaction includes at least one of: a sliding operation associated with a first interactive area of the information display area; or a click operation associated with a second interactive area of the information display area.

In some embodiments, the second presentation module 520 is further configured to present, in the information display area, a card component corresponding to the first description information.

In some embodiments, the apparatus 500 further includes an animation module configured to, in response to receiving the first interaction, present an animation process of switching a first card component corresponding to the first description information to a second card component corresponding to the second description information.

In some embodiments, the apparatus 500 further includes an indication module configured to: present, in the interactive interface, an indication element associated with the set of description information, the set of description information corresponding to a set of interactions of a group of users to the content; and in response to the information display area switching to present the second description information, update the indication element to indicate an order of the second description information in the set of description information.

In some embodiments, the first description information includes at least one of the following: a comment added by the first user to recommend the content; identification information of the first user; or time information of the first user recommending the content.

In some embodiments, the first interaction and/or the second interaction includes a recommendation operation for the content.

In some embodiments, the apparatus 500 further includes an obtaining module configured to: present a set of interactive controls in the input panel; and obtain the input information in response to a selection of a target interactive control in the set of interactive controls.

In some embodiments, a control type and/or a display order of the set of interactive controls is determined based on at least one of: first reference information associated with the content; second reference information associated with the current user; or third reference information associated with the first user or the second user.

In some embodiments, a display style of the first description information is determined based on a length of comment content added by the first user for the first interaction.

The units included in the apparatus 500 may be implemented in various manners, including software, hardware, firmware, or any combination thereof. In some embodiments, one or more units may be implemented using software and/or firmware, such as machine-executable instructions stored on a storage medium. In addition to or as an alternative to machine-executable instructions, some or all of the elements in the apparatus 500 may be implemented, at least in part, by one or more hardware logic components. By way of example and not limitation, example types of hardware logic components that may be used include field programmable gate arrays (FPGAs), application specific integrated circuits (ASICs), application specific standards (ASSPs), system-on-a-chip (SOCs), complex programmable logic devices (CPLDs), and the like.

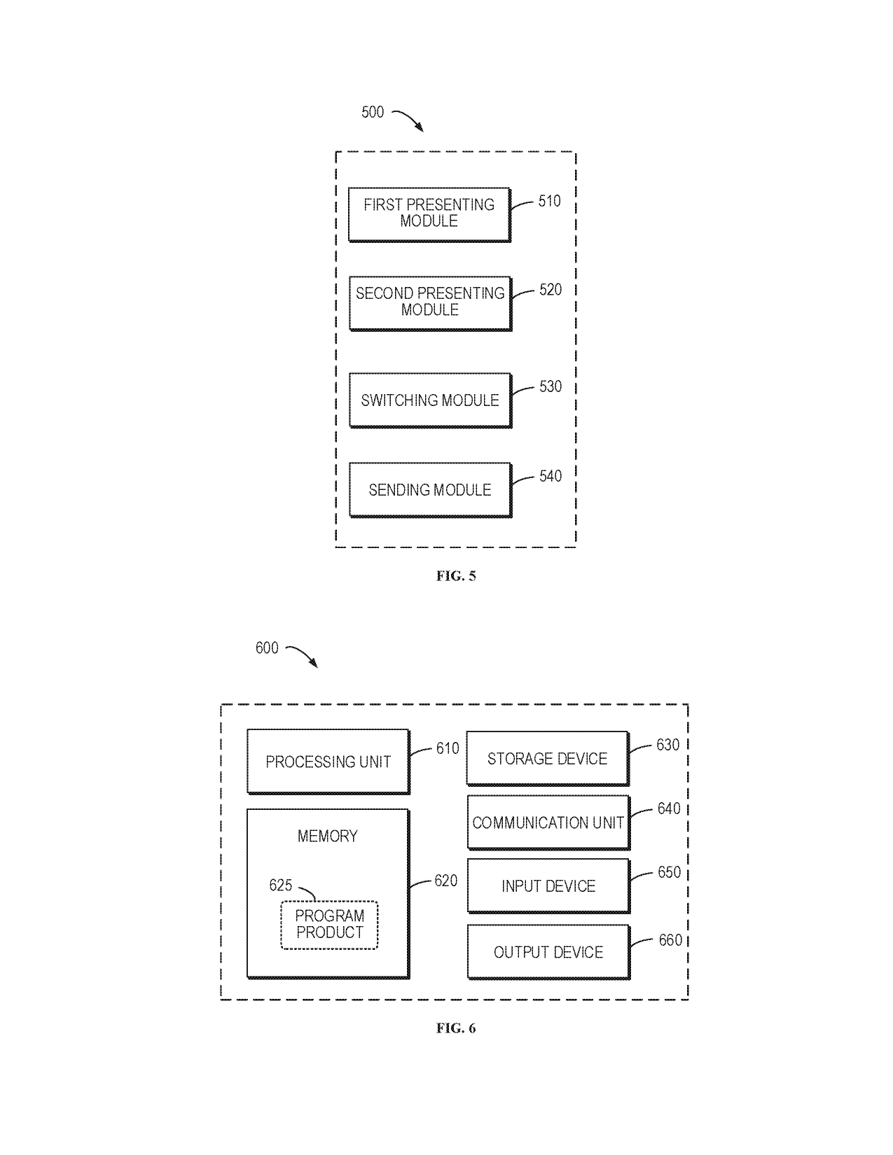

FIG. 6 illustrates a block diagram of an electronic device 600 in which one or more embodiments in the disclosure may be implemented. It should be understood that the electronic device 600 illustrated in FIG. 6 is merely example and should not constitute any limitation on the functionality and scope of the embodiments described herein. The electronic device 600 shown in FIG. 6 may be used in an electronic device.

As shown in FIG. 6, the electronic device 600 is in the form of a general-purpose electronic device. Components of the electronic device 600 may include, but are not limited to, one or more processors or processing units 610, a memory 620, a storage device 630, one or more communication units 640, one or more input devices 650, and one or more output devices 660. The processing unit 610 may be an actual or virtual processor and capable of performing various processes according to programs stored in the memory 620. In multiprocessor systems, multiple processing units execute computer-executable instructions in parallel to improve parallel processing capabilities of electronic device 600.

Electronic device 600 typically includes a plurality of computer storage media. Such media may be any available media accessible to the electronic device 600, including, but not limited to, volatile and non-volatile media, removable and non-removable media. The memory 620 may be volatile memory (e.g., registers, caches, random access memory (RAM)), non-volatile memory (e.g., read-only memory (ROM), electrically erasable programmable read-only memory (EEPROM), flash memory), or some combination thereof. Storage device 630 may be a removable or non-removable medium and may include a machine-readable medium, such as a flash drive, magnetic disk, or any other medium, which may be capable of storing information and/or data and may be accessed within electronic device 600.

The electronic device 600 may further include additional removable/non-removable, volatile/non-volatile storage media. Although not shown in FIG. 6, a disk drive for reading or writing from a removable, nonvolatile magnetic disk (e.g., a “floppy disk”) and an optical disk drive for reading or writing from a removable, nonvolatile optical disk may be provided. In these cases, each drive may be connected to a bus (not shown) by one or more data media interfaces. The memory 620 may include a computer program product 625 having one or more program modules configured to perform various methods or actions of various embodiments in the disclosure.

The communication unit 640 is configured to communicate with another electronic device through a communication medium. Additionally, the functionality of components of the electronic device 600 may be implemented in a single computing cluster or multiple computing machines capable of communicating over a communication connection. Thus, the electronic device 600 may operate in a networked environment using logical connections with one or more other servers, network personal computers (PCs), or another network node.

The input device 650 may be one or more input devices such as a mouse, a keyboard, a trackball, or the like. The output device 660 may be one or more output devices, such as a display, a speaker, a printer, or the like. The electronic device 600 may also communicate with one or more external devices (not shown) through the communication unit 640 as needed, external devices such as storage devices, display devices, etc. , communicate with one or more devices that enable a user to interact with the electronic device 600, or communicate with any device (e.g., a network card, a modem, etc. ) that enables the electronic device 600 to communicate with one or more other electronic devices. Such communication may be performed via an input/output (I/O) interface (not shown).

According to example implementations in the disclosure, there is provided a computer-readable storage medium having computer-executable instructions stored thereon, where the computer-executable instructions are executed by a processor to implement the method described above. According to example implementations in the disclosure, a computer program product is further provided, the computer program product being tangibly stored on a non-transitory computer-readable medium and including computer-executable instructions, the computer-executable instructions being executed by a processor to implement the method described above.

Aspects in the disclosure are described herein with reference to flowcharts and/or block diagrams of methods, apparatuses, devices, and computer program products implemented in accordance with the disclosure. It should be understood that each block of the flowchart and/or block diagram, and combinations of blocks in the flowcharts and/or block diagrams, may be implemented by computer readable program instructions.

These computer-readable program instructions may be provided to a processing unit of a general purpose computer, special purpose computer, or other programmable data processing apparatus to produce a machine, such that the instructions, when executed by a processing unit of a computer or other programmable data processing apparatus, produce means to implement the functions/acts specified in the flowchart and/or block diagram. These computer-readable program instructions may also be stored in a computer-readable storage medium that cause the computer, programmable data processing apparatus, and/or other devices to function in a particular manner, such that the computer-readable medium storing instructions includes an article of manufacture including instructions to implement aspects of the functions/acts specified in the flowchart and/or block diagram (s).

The computer-readable program instructions may be loaded onto a computer, other programmable data processing apparatus, or other apparatus, such that a series of operational steps are performed on a computer, other programmable data processing apparatus, or other apparatus to produce a computer-implemented process such that the instructions executed on a computer, other programmable data processing apparatus, or other apparatus implement the functions/acts specified in the flowchart and/or block diagram block or blocks.

The flowchart and block diagrams in the figures show architecture, functionality, and operation of possible implementations of systems, methods, and computer program products according to various implementations in the disclosure. In this regard, each block in the flowchart or block diagram may represent a module, program segment, or portion of an instruction that includes one or more executable instructions for implementing the specified logical function. In some alternative implementations, the functions noted in the blocks may also occur in a different order than noted in the figures. For example, two consecutive blocks may actually be performed substantially in parallel, which may sometimes be performed in the reverse order, depending on the functionality involved. It is also noted that each block in the block diagrams and/or flowchart, as well as combinations of blocks in the block diagrams and/or flowchart, may be implemented with a dedicated hardware-based system that performs the specified functions or actions, or may be implemented in a combination of dedicated hardware and computer instructions.

Various implementations in the disclosure have been described above, which are examples, not exhaustive, and are not limited to the implementations disclosed. Many modifications and variations will be apparent to those of ordinary skill in the art without departing from the scope and spirit of the various implementations illustrated. The selection of the terms used herein is intended to best explain the principles of the implementations, practical applications, or improvements to techniques in the marketplace, or to enable others of ordinary skill in the art to understand the various implementations disclosed herein.

What is claimed is:

1. A method for interface interaction, comprising:
presenting an input panel and an information display area in an interactive interface of a content;
presenting first description information in the information display area, the first description information indicating a first interaction of a first user to the content;
switching, in response to receiving the first interaction, the information display area to present second description information indicating a second interaction of a second user to the content; and
sending, based on first input information received via the input panel, a message corresponding to the first input information to the second user.

2. The method of claim 1, wherein presenting the input panel and the information display area in the interactive interface of the content comprises:
in response to receiving a viewing request associated with the content, presenting an interactive panel associated with the content, the interactive panel presenting a set of description information at least comprising the first description information; and
in response to a selection of the first description information in the set of description information, presenting the input panel and the information display area.

3. The method of claim 2, wherein the interactive panel further comprises a group interaction entry, and the method further comprises:
in response to a selection of the group interaction entry in the interactive panel, sending a message associated with the content in a target group that is created based on the selection of the group interaction entry.

4. The method of claim 3, wherein the target group comprises at least one user determined from a set of users that have recommended the content, and an association relationship between the at least one user and a current user satisfies a predetermined condition.

5. The method of claim 4, further comprising:
presenting a group of candidate users determined from a group of users corresponding to the set of description information, the association relationship between the group of candidate users and the current user satisfying the predetermined condition; and
receiving a selection of the at least one user in the group of candidate users to be added to the target group.

6. The method of claim 5, wherein presenting the group of candidate users determined from the group of users corresponding to the set of description information comprises:
presenting the group of candidate users in a group configuration interface before creating the target group; or
presenting the group of candidate users in a conversation interface of the target group after creating the target group.

7. The method of claim 2, further comprising:
presenting, in the interactive panel, an input control associated with an interaction;
presenting a recommendation panel in the interactive interface in response to a selection of the input control; and
obtaining, via the recommendation panel, second input information as a comment added by the current user for the interaction of the content.

8. The method of claim 2, wherein the interactive interface comprises a viewing interface of the content, and the method further comprises:
presenting a target element in the viewing interface, the target element indicating an interaction associated with the content; and
presenting the interactive panel in response to triggering of the target element.

9. The method of claim 2, further comprising:
presenting, in the interactive panel, a set of cards corresponding to the set of description information.

10. The method of claim 2, further comprising:
in response to receiving the first interaction, determining the second description information from the set of description information based on a display order of the set of description information in the interactive panel.

11. The method of claim 1, wherein the first interaction comprises at least one of:
a sliding operation associated with a first interactive area of the information display area; or
a click operation associated with a second interactive area of the information display area.

12. The method of claim 1, wherein presenting the first description information comprises:
presenting a card component corresponding to the first description information in the information display area.

13. The method of claim 12, further comprising:
in response to receiving the first interaction, presenting an animation process of switching a first card component corresponding to the first description information to a second card component corresponding to the second description information.

14. The method of claim 1, further comprising:
presenting an indication element associated with a set of description information in the interaction interface, the set of description information corresponding to a set of interactions of a group of users to the content; and
in response to the information display area switching to present the second description information, updating the indication element to indicate an order of the second description information in the set of description information.

15. The method of claim 1, wherein the first description information comprises at least one of:
a comment added by the first user to recommend the content;
identification information of the first user; or
time information associated with the first interaction,
and
wherein a display style of the first description information is determined based on a length of comment content added by the first user for the first interaction.

16. The method of claim 1, wherein the first interaction and/or the second interaction comprises a recommendation operation for the content.

17. The method of claim 1, further comprising:
presenting a set of interactive controls in the input panel; and
obtaining the input information in response to a selection of a target interactive control in the set of interactive controls.

18. The method of claim 17, wherein a control type and/or a display order of the set of interactive controls is determined based on at least one of:
first reference information associated with the content;
second reference information associated with the current user; or
third reference information associated with the first user or the second user.

19. An electronic device, comprising:
at least one processor; and
at least one memory coupled to the at least one processor and storing instructions for execution by the at least one processor, the instructions, when executed by the at least one processor, causing the electronic device to perform operations for interface interaction comprising:
presenting an input panel and an information display area in an interactive interface of a content;
presenting first description information in the information display area, the first description information indicating a first interaction of a first user to the content;
switching, in response to receiving the first interaction, the information display area to present second description information indicating a second interaction of a second user to the content; and
sending, based on first input information received via the input panel, a message corresponding to the first input information to the second user.

20. A non-transitory computer-readable storage medium having stored thereon a computer program executable by a processor to implement a method for interface interaction, comprising:
presenting an input panel and an information display area in an interactive interface of a content;
presenting first description information in the information display area, the first description information indicating a first interaction of a first user to the content;
switching, in response to receiving the first interaction, the information display area to present second description information indicating a second interaction of a second user to the content; and
sending, based on first input information received via the input panel, a message corresponding to the first input information to the second user.
